(19) United States
(12) Patent Application Publication
(10) Pub. No.: US 2005/0126986 A1
(43) Pub. Date: Jun. 16, 2005

(54) Papermaking screen device

(75) Inventor: Yoshihiko Aikawa, Shizuoka-shi (JP)

Correspondence Address: HAUPTMAN KANESAKA & BERNER;Suite 300, 1700 Diagonal Road, Alexandria, VA, 22314, US

(73) Assignee: AIKAWA IRON WORKS CO., LTD

(21) Appl. No.: 10/944,391

(22) Filed: Sep. 20, 2004

(30) Foreign Application Priority Data
Dec. 15, 2003 (JP) 2003-416278

(51) Int. Cl. B01D 29/07; B01D 39/10

(52) U.S. Cl. 210/499

(57) ABSTRACT

A papermaking screen device includes a tank for receiving papermaking raw materials; an agitator provided in the tank; a screen provided in the tank; and a partition wall for dividing the screen and the tank. The tank includes a first chamber located at an outer side of the screen for receiving the papermaking raw materials; a second chamber located at an inner side of the screen; and a third chamber located at the outer side of the screen for discharging the papermaking raw materials. The first chamber is connected to a supply passage for supplying the papermaking raw materials into the tank and a first discharge passage for discharging the papermaking raw materials. The second chamber is connected to a second discharge passage for discharging the papermaking raw materials. The third chamber is connected to a discharge passage for discharging the papermaking raw materials to an outside of the tank.

### BACKGROUND OF THE INVENTION AND RELATED ART STATEMENT

The present invention relates to a papermaking screen device, and especially, to a papermaking screen device capable of replacing a screen easily.

A papermaking screen device generally includes an external cylinder screen located on an outer side of a screen basket; and an agitator located between the screen basket and the external cylinder screen. Papermaking raw materials pass twice through the external cylinder screen and the screen basket (refer to Japanese Utility Model Publication (Kokai) No. 06-40636). In such a papermaking screen device, the external cylinder screen and the screen basket may be damaged by foreign materials contained in the papermaking raw materials. In such a case, the damaged screen basket and the damaged external cylinder screen need to be replaced individually. At the same time, especially when the screen basket located in the inner side of the external cylinder screen needs to be replaced, it is necessary to remove the agitator located between the screen basket and the external cylinder screen to replace the screen basket, thereby making the replacement troublesome.

In view of the above-mentioned problem, the present invention has been made, and an object of the invention is to provide a papermaking screen device capable of replacing a screen easily.

Further objects and advantages of the invention will be apparent from the following description of the invention.

### SUMMARY OF THE INVENTION

In order to achieve the above-mentioned objects, according to a first aspect of the present invention, a papermaking screen device includes a tank for receiving papermaking raw materials; an agitator provided in the tank; a screen provided in the tank at an outer side of the agitator; and a partition wall for dividing the screen and the tank. The tank includes a first chamber located at the outer side of the screen for receiving the papermaking raw materials; a second chamber located at an inner side of the screen where the agitator is disposed; and a third chamber located at the outer side of the screen for discharging the papermaking raw materials. The first chamber is connected to a papermaking raw material supply passage for supplying the papermaking raw materials into the tank and a first discharge passage for discharging the papermaking raw materials inside the first chamber that do not pass through the screen. The second chamber is connected to a second discharge passage for discharging the papermaking raw materials that are not guided to the third chamber. The third chamber is connected to a papermaking raw material discharge passage for discharging the papermaking raw materials that pass through the screen to an outside of the tank.

According to a second aspect of the present invention, in the papermaking screen device of the first aspect, the partition wall is provided with an opening in an inner circumference thereof for discharging dilution water toward the agitator.

In the papermaking screen device of the first aspect, the papermaking raw materials pass through the screen several times. The screen is located at the outside of the agitator, so that the screen can be replaced without removing the agitator. Further, the screen is formed in a single member, thereby making it easy to install and remove.

### BRIEF DESCRIPTION OF THE DRAWINGS

FIG. 1 is a cross sectional view showing a papermaking screen device according to an embodiment of the present invention;

FIG. 2 is a partially enlarged sectional view showing a part of the papermaking screen device shown FIG. 1;

FIG. 3 is a cross sectional view taken along line 3-3 in FIG. 1;

FIG. 4 is a cross sectional view taken along line 4-4 in FIG. 1; and

FIG. 5 is a cross sectional view showing a papermaking screen device according to another embodiment.

### DETAILED DESCRIPTION OF PREFERRED EMBODIMENTS

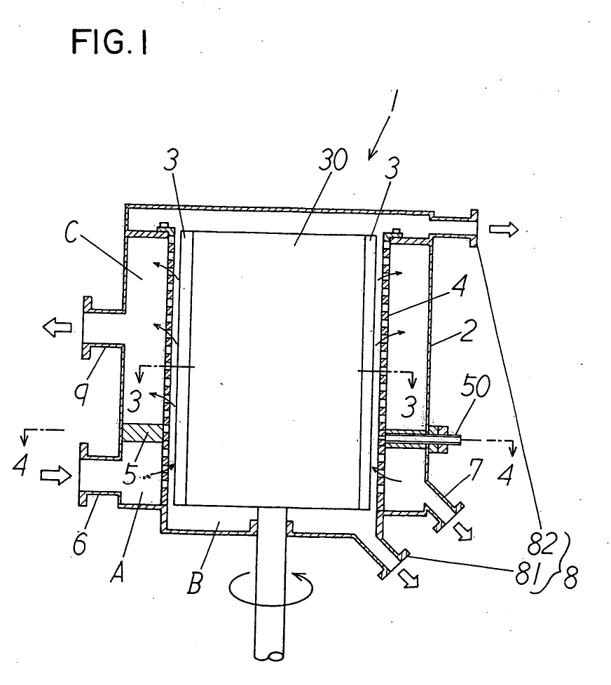

Hereunder, embodiments of the present invention will be explained with reference to the accompanying drawings. In FIG. 1, reference numeral 1 represents a papermaking screen device, and the papermaking screen device 1 includes a tank 2 for receiving papermaking raw materials. Agitators 3 are provided inside the tank 2, and are formed on an outer circumference of a rotor 30. The agitators 3 push a screen 4 at a front portion thereof, and scrape a mesh of the screen 4 at a rear portion thereof.

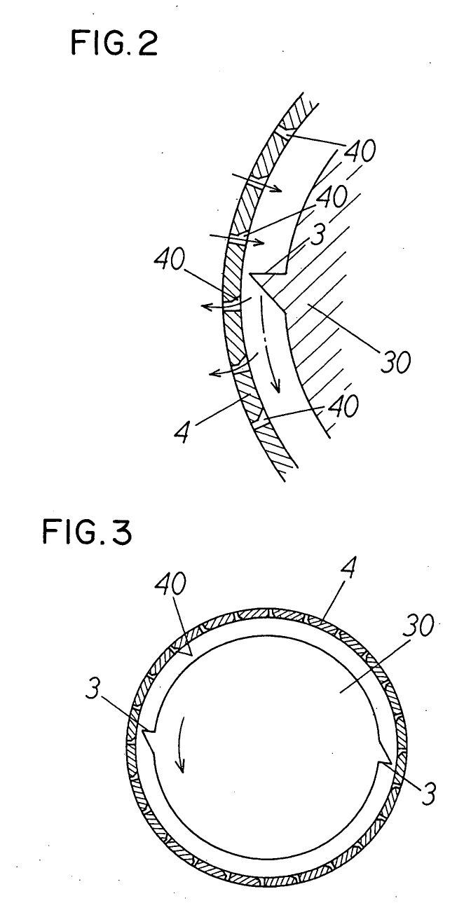

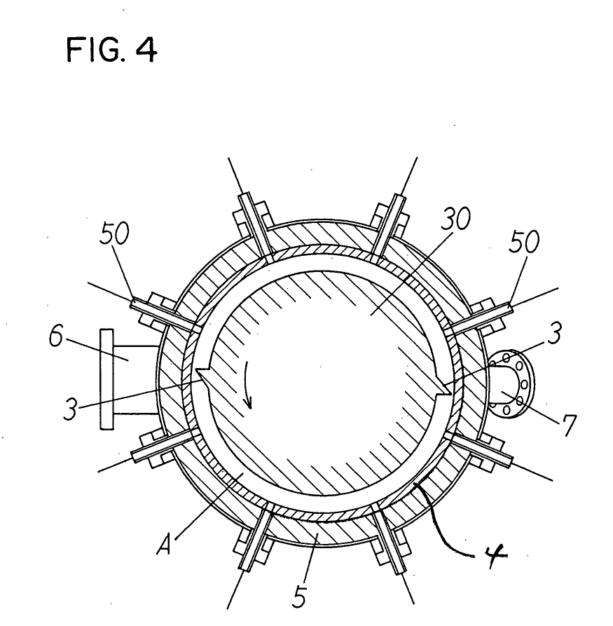

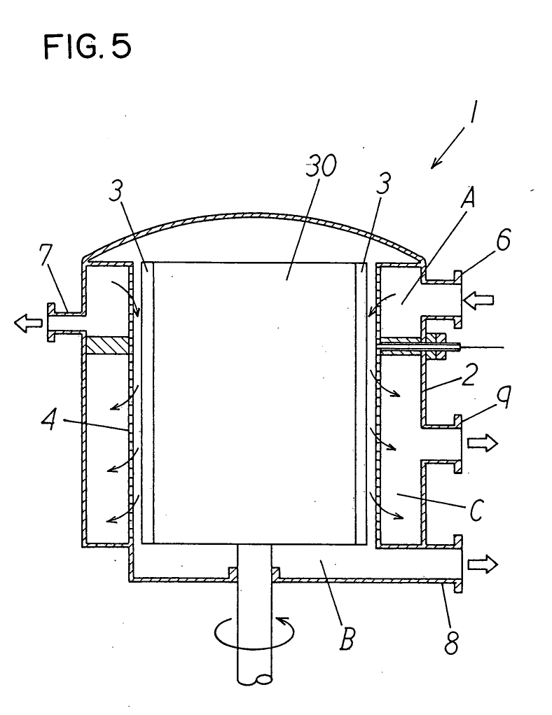

The screen 4 is located in the tank 0.2 at an outside of the agitators 3, and has a shape such as a tube shape with two open ends. As shown in FIGS. 2 and 3, the screen 4 is provided with passages 40 for passing the papermaking raw materials therethrough, and the passages 40 have a shape expanding toward a side facing the agitators 3. Reference numeral 5 represents a partition wall for dividing the screen 4 and the tank 2, and has a shape such as a doughnut shape. As shown in FIG. 4, the partition wall 5 has openings in an inner circumference thereof, so that dilution water is discharged toward the agitators 3 through the openings. Reference numeral 50 represents dilution water supply passages such as pipes for supplying dilution water.

The tank 2 includes a first chamber A located at an outer side of the screen 4 as a receiving side of the papermaking raw materials; a second chamber B located at an inner side of the screen 4 where the agitators 3 are located; and a third chamber C located at the outer side of the screen 4 as a discharging side of the papermaking raw materials.

The first chamber A is connected to a papermaking raw material supply passage 6 for supplying the papermaking raw materials into the tank 2; and a first discharge passage 7 for discharging the papermaking raw materials in the first chamber A that do not pass through the screen 4. Also, the second chamber B is connected to second discharge passages 8 (81 and 82) for discharging the papermaking raw materials that are not guided to the third chamber C. The second discharge passages 8 include a discharge passage 81 located at a lower side of the tank 2 for discharging heavy foreign materials; and a discharge passage 82 located at an upper side of the tank 2 for discharging light foreign materials. Also, the third chamber C is connected to a papermaking raw material discharge passage 9 for discharging the papermaking raw materials that are passed and selected through the screen 4 to an outside of the tank 2.

In the papermaking screen device, the papermaking raw materials pass through the papermaking raw material supply passage 6, and are received in the first chamber A inside the tank 2. While a part of the papermaking raw materials in the first chamber A passes through the screen 4, foreign materials contained in the papermaking raw materials can not pass through the screen 4, and remain in the first chamber A. When a valve (not shown) provided in the first discharge passage 7 is opened, the foreign materials contained in the papermaking raw materials are guided to the outside of the tank 2 through the first discharge passage 7.

The papermaking raw materials guided to the second chamber B are agitated by the agitators (agitating members) 3, and a part of the papermaking raw materials passes through the screen 4 and is guided to the third chamber C. The papermaking raw materials guided to the third chamber C are guided to the outside of the tank 2 through the papermaking raw material discharge passage 9. The papermaking raw materials containing a relatively large number of foreign materials do not pass through the screen 4 and remain in the second chamber B. The foreign materials are guided to the outside of the tank 2 through the second discharge passages 8 (81, 82) when a valve (not shown) provided in the second discharge passages 8 (81, 82) is opened. At this time, using a difference in specific gravity, light foreign bodies are discharged through the discharge passage 81, and heavy foreign bodies are discharged through the discharge passage 82, respectively.

In the present embodiment, the dilution water supply passages 50 such as pipes are provided, individually. The present invention is not limited to the present embodiment. Although it is not shown in the drawings, a chamber with a number of dilution water supply passages may be provided at the inside or the outside of the tank 2, or the inside and the outside of the tank 2, so that water can be supplied to the chamber through one pipe.

When the screen 4 is damaged by foreign materials contained in the papermaking raw materials while the papermaking screen device 1 is used, it is possible to replace the screen 4 without removing the agitators 3 since the screen 4 is located at the outside of the agitators 3. Also, the screen 4 is formed in a single member, thereby making it easy to install and remove.

In the papermaking screen device 1 shown in FIGS. 1 to 4, the papermaking raw material supply passage 6 is provided at the lower side of the tank 2 for supplying the papermaking raw materials, and the papermaking raw material discharge passage 9 is provided at the upper side above the center of the tank 2 for discharging the papermaking raw materials after passing through the screen 4 to the outside of the tank 2. The invention is not limited to the papermaking screen device 1 described above. As shown in FIG. 5, the papermaking raw material supply passage 6 may be provided at the upper side of the tank 2 for supplying the papermaking raw materials. Also, the papermaking raw material discharge passage 9 may be provided at the lower side below the center of the tank 2 for discharging the papermaking raw materials after passing through the screen 4 to the outside of the tank 2.

In the papermaking screen device 1 shown in FIGS. 1 to 4, the second discharge passages 8 include the two discharge passages, i.e. the discharge passage 81 for discharging the heavy foreign materials and the discharge passage 82 for discharging the light foreign materials. The invention is not limited to the papermaking screen device 1 described above. As shown in FIG. 5, one second discharge passage 8 is provided for discharging the papermaking raw materials containing a lot of foreign materials in the second chamber B.

The disclosure of Japanese Patent Application No. 2003-416278, filed on Dec. 15, 2003, is incorporated in the Application.

While the invention has been explained with reference to the specific embodiments of the invention, the explanation is illustrative and the invention is limited only by the appended claims.

1. A papermaking screen device for screening a papermaking raw material, comprising:
a tank for receiving the papermaking raw material,
an agitator disposed in the tank for agitating the papermaking raw material,
a screen disposed in the tank outside the agitator for screening the papermaking raw material,
a partition wall situated between the screen and the tank,
a first chamber disposed in the tank outside the screen,
a second chamber disposed in the tank inside the screen for retaining the agitator and communicating with the first chamber through the screen,
a third chamber disposed in the tank outside the screen and communicating with the second chamber through the screen,
a papermaking raw material supply passage connected to the first chamber for supplying the papermaking raw material from an outside of the tank,
a first discharge passage connected to the first chamber for discharging outside the tank a material in the papermaking raw material which does not pass through the screen,
a second discharge passage connected to the second chamber for discharging outside the tank a material in the papermaking raw material which does not enter the third chamber, and
a papermaking raw material discharge passage connected to the third chamber for discharging the papermaking raw material in the third chamber outside the tank.

2. A papermaking screen device according to claim 1, wherein said partition wall includes an opening in an inner circumference thereof for supplying dilution water toward the agitator therethrough.

3. A papermaking screen device according to claim 1, wherein said partition wall is disposed between the first chamber and the third chamber.

4. A papermaking screen device according to claim 2, further comprising a dilution water supply passage passing through the partition wall and connected to the opening.

5. A papermaking screen device according to claim 1, wherein said second discharge passage includes a lower discharge passage located at a lower side of the second chamber for discharging a heavy foreign material in the papermaking raw material and an upper discharge passage located at an upper side of the second chamber for discharging a light foreign material in the papermaking raw material.
